(19) United States
(12) Patent Application Publication
(10) Pub. No.: US 2023/0033463 A1
(43) Pub. Date: Feb. 2, 2023

(54) LABWARE TRANSPORT ROBOT

(71) Applicant: HIGHRES BIOSOLUTIONS, INC., Beverly, MA (US)

(72) Inventor: Ulysses GILCHRIST, Reading, MA (US)

(21) Appl. No.: 17/812,334

(22) Filed: Jul. 13, 2022

Related U.S. Application Data
(60) Provisional application No. 63/222,244, filed on Jul. 15, 2021.

(51) Int. Cl. B25J 9/16; B25J 9/06; B25J 9/00; B25J 11/00; B25J 19/02

(52) U.S. Cl. CPC B25J 9/1653; B25J 9/1664; B25J 9/06; B25J 9/0009; B25J 11/00; B25J 19/02

(57) ABSTRACT

A labware transport apparatus includes a frame, defining a labware space, and a robotic multi-link arm operably connected to the frame via a drive section. The arm has a predetermined link configuration determining a minimum footprint of the arm and a corresponding maximum reach of an end effector of the robotic multi-link arm within a range of motion of the end effector. The range of motion, at least in part of the labware space, of the end effector is delimited by a blockage of a substantially vertical axis of motion, of the drive section of the robotic multi-link arm, extending through the range of motion, wherein the blockage is sized and shaped based on and so as to maximize the range of motion of the end effector of the robotic multi-link arm having the predetermined link configuration that is common determining the minimum foot print and the corresponding maximum reach.

### CROSS-REFERENCE TO RELATED APPLICATIONS

This application is a non-provisional of and claims the benefit of U.S. provisional patent application No. 63/222,244 filed on Jul. 15, 2021, the disclosure of which is incorporated herein by reference in its entirety.

### BACKGROUND

### 1. Field

The disclosed embodiment generally relates to life sciences equipment, and more particularly, to automated handling and processing of life sciences processing equipment.

### 2. Brief Description of Related Developments

Generally labware transport robotics are employed to transfer labware within a robotic workspace. These conventional labware transport robotics include a robotic arm that is coupled to a vertical Z-axis (e.g., vertical linear track or column) so that the robotic arm is able to move an end effector thereof in three dimensional space. To provide end effector access to a full 360° range of motion the vertical column of the Z-axis is provided with a rotational motor that rotates the vertical column and the robotic arm about a central axis of rotation so as to change the angular (horizontal) orientation of the robotic arm. The Z-axis and the robotic arm mounted thereto have a large mass moment of inertia where typically a large and costly motor is employed to rotate the Z-axis and the robotic arm mounted thereto.

In some instances the above-noted labware transport robotics are employed in collaborative work spaces alongside human operators. Here, the labware transport robotics comply with certain standards such as, for example, International Organization for Standardization (ISO) standard 10218 (inclusive of 10218-1:2011 and 10218-2:2011) and ISO/TS 15066:2016. Generally costly and bulky padding is included at least along the Z-axis of movement to reduce at least Z-axis impact forces to levels that comply with the above-noted standards.

### BRIEF DESCRIPTION OF THE DRAWINGS

The foregoing aspects and other features of the disclosed embodiment are explained in the following description, taken in connection with the accompanying drawings, wherein:

FIG. 1A is an exemplary robotic processing system incorporating aspects of the disclosed embodiment;

FIG. 1B is a portion of the exemplary robotic processing system of FIG. 1A incorporating aspects of the disclosed embodiment;

FIG. 1C is a portion of the exemplary robotic processing system of FIG. 1A incorporating aspects of the disclosed embodiment;

FIG. 2 is an exemplary robotic processing system incorporating aspects of the disclosed embodiment;

FIG. 3A is a schematic perspective illustration of an exemplary labware transport apparatus of FIGS. 1A-2 in accordance with aspects of the disclosed embodiment;

FIG. 3B is a schematic elevation view of the exemplary labware transport apparatus of FIG. 3A in accordance with aspects of the disclosed embodiment;

FIG. 3C is a schematic plan view of the exemplary labware transport apparatus of FIG. 3A in accordance with aspects of the disclosed embodiment;

FIG. 4 is a schematic plan view of the exemplary labware transport apparatus of FIG. 3A in accordance with aspects of the disclosed embodiment;

FIG. 5 is a schematic plan view of the exemplary labware transport apparatus of FIG. 3A in accordance with aspects of the disclosed embodiment;

FIG. 6 is a schematic plan view of the exemplary labware transport apparatus of FIG. 3A in accordance with aspects of the disclosed embodiment;

FIG. 7 is a schematic plan view of a portion of the exemplary labware transport apparatus of FIG. 3A in accordance with aspects of the disclosed embodiment;

FIGS. 8A and 8B are schematic plan illustrations of the portion of the exemplary labware transport apparatus of FIG. 7 effecting a labware center detection operation in accordance with aspects of the disclosed embodiment;

FIG. 9 is a flow diagram of an exemplary method in accordance with aspects of the disclosed embodiment; and

FIG. 10 is a flow diagram of an exemplary method in accordance with aspects of the disclosed embodiment.

### DETAILED DESCRIPTION

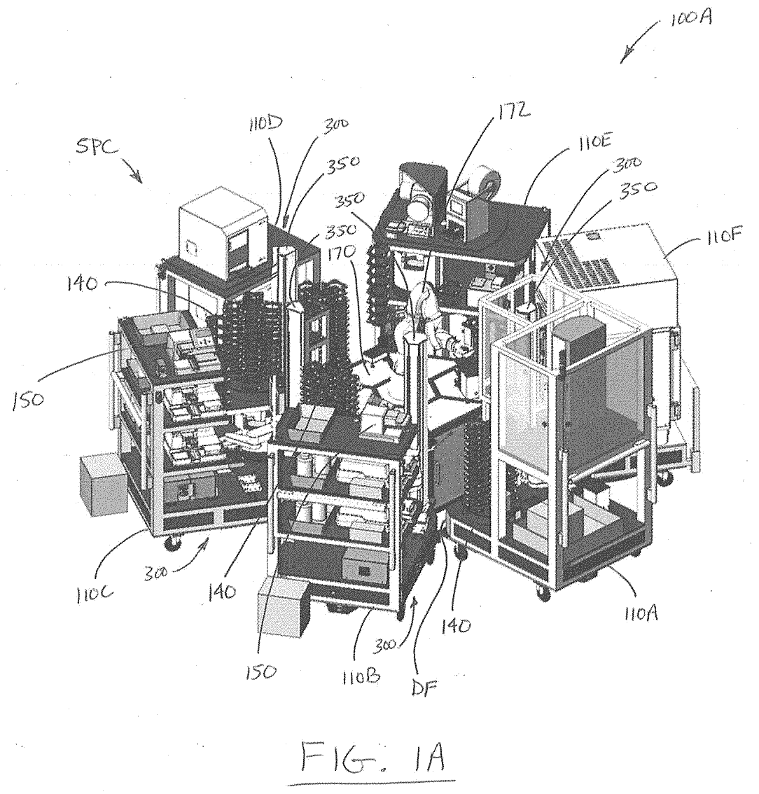

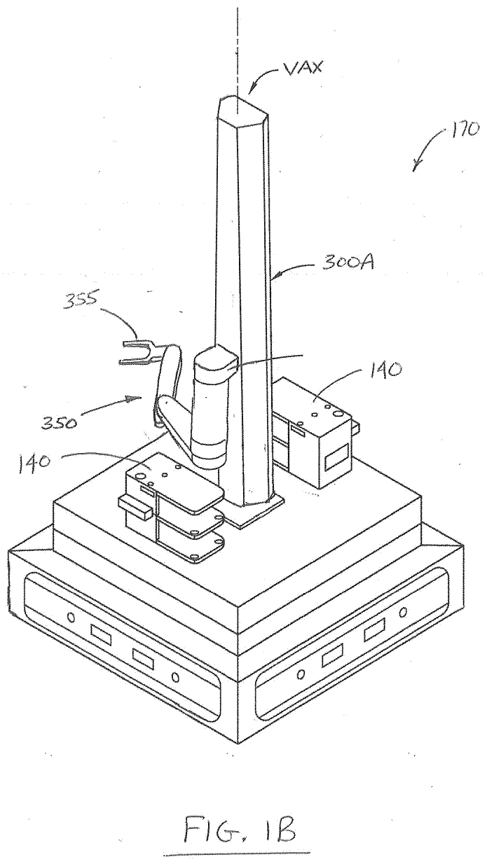

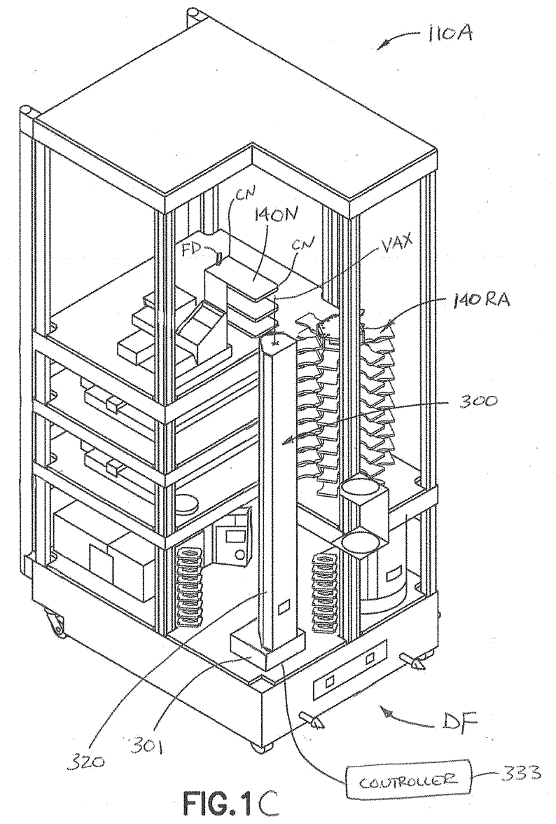

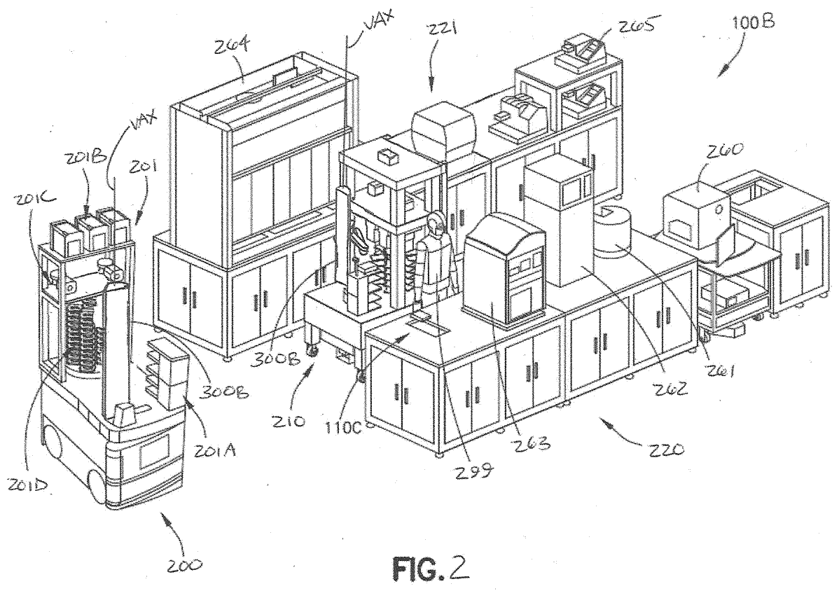

FIGS. 1A, 1B, and 2 illustrate exemplary robotic processing systems 100A, 100B in accordance with aspects of the disclosed embodiment. Although the aspects of the disclosed embodiment will be described with reference to the drawings, it should be understood that the aspects of the disclosed embodiment can be embodied in many forms. In addition, any suitable size, shape or type of elements or materials could be used.

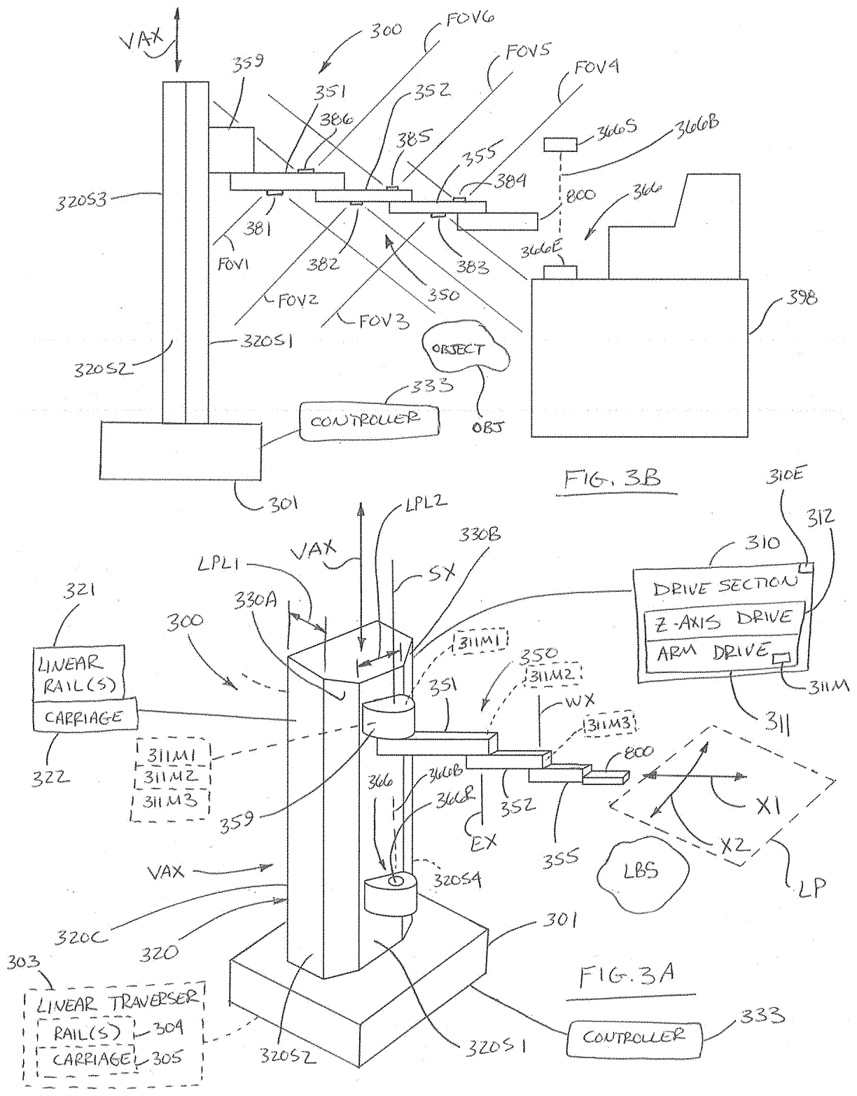

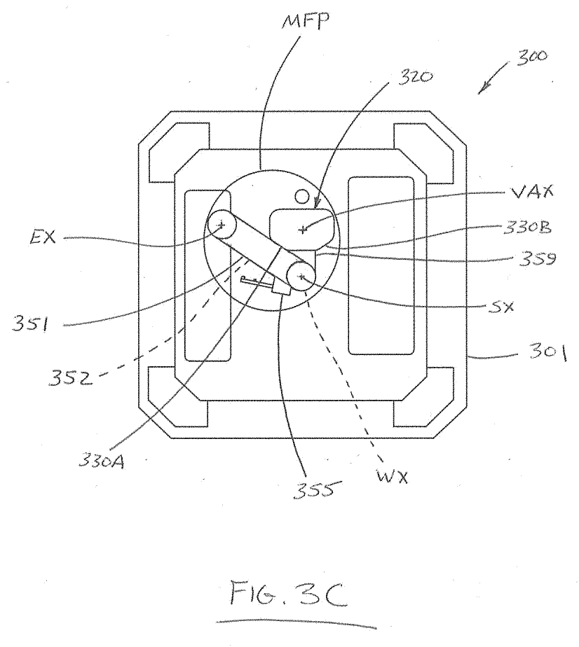

The aspects of the disclosed embodiment, referring also to FIGS. 3A and 3B, provide the robotic processing systems 100A, 100B with a labware transport apparatus 300 that includes a robotic multi-link arm 350 (referred to herein as an “arm” or “robotic transport arm”) that has an end effector 355 movable throughout a range of motion. The arm 350 is movable along a substantially vertical (Z-axis) of motion VAX that delimits the movement of the end effector 355 in the range of motion. The aspects of the disclosed embodiment provide for the range of motion of the end effector being a 360° range of motion regardless of the presence of the obstructing Z-axis of motion VAX, and without rotation of the Z-axis of motion VAX and the arm 350 as a unit. Without the rotation of the Z-axis of motion VAX the aspects of the disclosed embodiment reduce costs of the labware transport apparatus 300 and simplify construction of the labware transport apparatus 300 compared to the conventional labware transport robotics described herein. As described herein, the labware transport apparatus 300 has a non-rotating Z-axis and provides for a 360° workspace range of motion of the labware transport apparatus 300 end effector 355 that is the same or similar to the conventional labware transport robotics (described above) having the Z-axis vertical column that rotates to change the extension direction of the conventional labware transport robotics arm.

The aspects of the disclosed embodiment also provide the arm 350 with an obstacle detection sensor suite configured to detect transient obstacles/objects OBJ (see FIG. 3B) within a workspace of the labware transport apparatus 300. The labware transport apparatus 300 is configured to, based on sensor signals from the obstacle detection sensor suite, stop or slow movement of the arm 350 to a level that reduces impact forces with the obstacle (if the obstacle is impacted) to levels that comply with, for example, ISO standard 10218 (inclusive of 10218-1:2011 and 10218-2:2011) and ISO/TS 15066:2016 as well as other collaborative robotic impact force standards in effect at the time of filing of this writing. The obstacle detection sensor suite reduces the mass moment of inertial of the arm 350 along at least the Z-axis of motion VAX and the size of the labware transport apparatus 300 in general compared to the conventional labware transport robotics described herein. The reduction of the mass moment of inertia of the arm 350 and the size of the labware transport apparatus 300 allows for placement of the labware transport apparatus 300 in locations where the conventional labware transport robotics typically will not fit.

Still referring to FIGS. 1A and 1B, in one aspect, a collaborative operating space SPC is provided in robotic processing system 100A. One or more mobile carts 110A-110F of the robotic processing system 100 are located within the collaborative operating space SPC. The robotic processing system 100A may also include an automated system 170, disposed in the collaborative operating space SPC, to which the one or more mobile carts 110A-110F are operably interfaced. Each of the mobile carts 110A-110F may include one or more of a robotic transport arm 350, one or more workpiece holding stations or storage rack modules 140, an operator interface 150, and any other suitable instrumentation, processing and/or storage equipment suitable for interfacing with the workpiece(s) handled by the robotic processing system 100A. As may be realized, a user or operator may access one or more regions of the collaborative operating space SPC (e.g. interface 150, one or more holding stations 140, or other location on the mobile carts 110A-110F) directly, and at times such access may be coincident or coexistent with robotic transport arm 172, 350 operation within the collaborative operating space SPC (see also FIG. 2 described below). For example, an operator may place or pick a workpiece on or from a holding station 140 in anticipation of a robotic pick of that workpiece as an aspect of a collaborative action with the robotic transport arm 172, 350. Accordingly, in some aspects, the robotic transport arm 172, 350 and operator collaborate in the collaborative operating space SPC. In one aspect, each of the mobile carts 110A-110F includes one or more datum surfaces or features DF (see also FIG. 1C) that are in a known spatial relationship with a sensor (or other detectable feature) of a respective mobile cart 110A-110F. In one aspect, the features (such as robotic transport arms 350, workpiece holding stations 140, and any other instrumentation/equipment) of each mobile cart 110A-110F are in a known relationship with the one or more datum surfaces or features DF where the robotic processing system 100A may include a device or tool for sending a signal indicating the position of the mobile cart features to the automated system 170 as described in, for example, U.S. Pat. No. 10,583,554 issued on Mar. 10, 2020 and entitled “Instrument Turntable and Method for Use”, the disclosure of which is incorporated herein in its entirety. In one aspect, the one or more datum surfaces or features DF are detected by a collaborative robot guarding system for automated calibration/setup of system components for operation with the robotic transport system. Suitable examples of the collaborative robot guarding system are described in U.S. patent application Ser. No. 17/032,011 filed on Sep. 25, 2020 and titled “Robotic Transport System and Method Therefor,” the disclosure of which is incorporated herein by reference in its entirety.

In one aspect, the automated system 170 includes any suitable robotic transport arm 172 for accessing one or more features of the one or more mobile carts 110A-110F. In one aspect, the robotic transport arm may be a selective compliant articulated robot arm (SCARA arm) such arm 350 of labware transport apparatus 300A illustrated in FIG. 1B (noting labware transport apparatus 300A is substantially similar to labware transport apparatus 300), or any other arm suitable articulated arm (such as a six-axis articulated arm) for transporting workpieces in the collaborative space SPC. For example, the robotic transport arm 172, 350 may be configured to access the workpiece holding stations 140, interface with other robotic transport arms 350, or interface/access any other suitable instrumentation/processing equipment of the one or more mobile carts 110A-110F as described in U.S. Pat. No. 10,583,554, the disclosure of which was previously incorporated herein by reference in its entirety. In one aspect, the automated system 170 is configured as a cluster tool and has a hexagonal configuration where six mobile carts are operably interfaced with six facets of the automated system 170. In other aspects, the automated system 170 may have any number of facets (e.g. pentagonal, octagonal, rectangular, etc.) so that any suitable number of mobile carts 110A-110F may be interfaced with the automated system 170. In other aspects, two or more robotic processing systems (in which the arm 350 described herein may be employed) may be operably coupled to each other in any suitable manner such as described in U.S. patent application Ser. No. 15/689,986 filed Aug. 29, 2017 (and published on Mar. 1, 2018 as United States pre-grant publication number 2018/0056528), U.S. Pat. Nos. 7,560,071, 8,734,720, 8,795,593, and U.S. Pat. No. 11,045,811 issued on Jun. 29, 2021, the disclosures of which are incorporated herein by reference in their entireties.

Referring to FIG. 2, another collaborative operating space SPC is illustrated in a laboratory facility/robotic processing system 100B that may include at least one auto-navigating robotic processing vehicle 200, 210 and at least one processing station 220, 221. In one aspect, the laboratory facility 100B may be substantially similar to that described in U.S. Pat. No. 10,955,430 issued on Mar. 23, 2021 and entitled “Auto-navigating Robotic Processing Vehicle”, the disclosure of which is incorporated herein by reference in its entirety. The at least one processing station 220, 221 may be a human operated processing station and/or an automated processing station. The auto-navigating robotic processing vehicles 200, 210 include a processing section 201 that has a number of different processing modules 201A-201D that are accessible with the labware transport apparatus 300B disposed on the least one auto-navigating robotic processing vehicle 200, 210. The labware transport apparatus 300B is substantially similar to labware transport apparatus 300 described herein. Each of the different processing modules 201A-201D has a different predetermined laboratory processing function with a different predetermined function characteristic corresponding to the processing module 210A-210D. The different processing modules 210A-210D and their respective functions are automatically selectable to effect, independent of or in combination with vehicle travel, a preprocess or a preprocess condition of laboratory samples and/or sample holders with respect to a process at the at least one processing station 220, 221. For example, preprocessing conditions that may be performed by the at least one auto-navigating robotic processing vehicle 200, 210 include, but are not limited to, storage of sample trays, sample tray lids, transport and direct or indirect handoff of laboratory equipment (e.g., vacuum heads, brushes, Bunsen burners, microscopes, brooms, processing tools and/or fixtures, sample trays, etc.) to a human 299 (at a processing station 220, 221), and/or automated processing equipment at a processing station 220, 221, cleaning of an animal cage, laboratory table, etc., Examples of processes that may be performed by the at least one auto-navigating robotic processing vehicle 200, 210 include, but are not limited to, removing a sealing film from a sample and/or sample tray, reading an identification of a sample and/or sample tray, etc., pipetting fluids, capping and decapping tubes.

In one aspect, the at least one auto-navigating robotic processing vehicle 200, 210 services individual processing stations 220, 221, where the processing stations 220, 221 have either automatic item (e.g., tools, samples, trays, etc.) input/output or have manual processes which are carried out/effected, monitored, and/or controlled (e.g., through a user interface) by a human 299. In one aspect, the at least one auto-navigating robotic processing vehicle 200, 210 is configured to provide all comporting (e.g., suitable) equipment (e.g., “process payloads” which may include process modules, peripherals, and/or consumables for station engagement, or “workpiece payloads” which may include samples and sample trays for station engagement) on the auto-navigating robotic processing vehicle 200, 210 to perform the tasks at a given processing station 220, 221. As an example, an auto-navigating robotic processing vehicle 200, 210 may be configured and loaded for an individual task such that all the comporting equipment is carried by a single auto-navigating robotic processing vehicle 200, 210 to complete the individual task (which may be, e.g., a process station function) in full with a single auto-navigating robotic processing vehicle 200, 210 and the items carried thereon.

The at least one auto-navigating robotic processing vehicle 200, 210 may also provide or otherwise generate, at each different human affectable process station 220, 221 (e.g., that has a common type of station process function, that includes one or more manual steps such as human affectable processes that include sterilization, exact timing control, climate control, temperature control, unattended use, remote control or monitoring) repeatable or “near identical” process steps (e.g., the process steps are performed with automatic machine repetition controlled by the at least one auto-navigating robotic processing vehicle's 200, 210 programmable controller).

Still referring to FIG. 2, the processing stations 220, 221 may be linearly arranged with one or more process tools 260-265 which may include, but are not limited to, electronic pipettes, microplate dispensers, media preparation modules (e.g., sterilization and dispensing of sample medium), environmental control modules (e.g., refrigeration, freezers, incubators, clean environments, hoods, etc.), storage modules, and centrifuges. It is noted that FIG. 2 illustrates human processing stations 220, 221 which may or not include automated processes however, the aspects of the disclosed embodiment are not limited to the human processing stations 220, 221. For example, the at least one auto-navigating robotic processing vehicle 200, 210 may also be configured to effect one or more predetermined laboratory processing function at a processing station of an automated configurable processing tool such as that described above with respect to FIGS. 1A and 1B in a manner substantially similar to that described in U.S. Pat. No. 10,955,430, the disclosure of which was previously incorporated by reference herein in its entirety.

Referring to FIGS. 3A and 3B, the labware transport apparatus 300 (also shown in FIGS. 1A-2) includes a frame 301 (at least a portion of which is illustrated in FIGS. 3A and 3B) that defines a labware space LBS (which labware space LBS may be coincident with a portion of the collaborative operating space SPC) in which the arm 350 operates. The frame 301 is configured to couple the labware transport apparatus 300 to a respective one of the automated system 170, mobile cart 110A-110F, auto-navigating robotic processing vehicle 200, 210, or any other suitable platform (e.g., bench, storage cabinet, etc.) of the robotic processing system 100A or laboratory facility 100B for transporting labware. In other aspects, the frame 301 may be integral to or part of the respective one of the automated system 170, mobile cart 110A-110F, auto-navigating robotic processing vehicle 200, 210, or the other suitable platform (e.g., bench, storage cabinet, etc.) of the robotic processing system 100A or laboratory facility 100B for transporting labware. The frame 301 may be mounted to a linear traverser or slide 303 (e.g., the frame 301 may be mounted to a carriage 305 that is driven along one or more rails or tracks 304 by any suitable linear actuator) that is configured to move the labware transport apparatus 300 along a linear traverse axis to expand the workspace area of the labware transport apparatus.

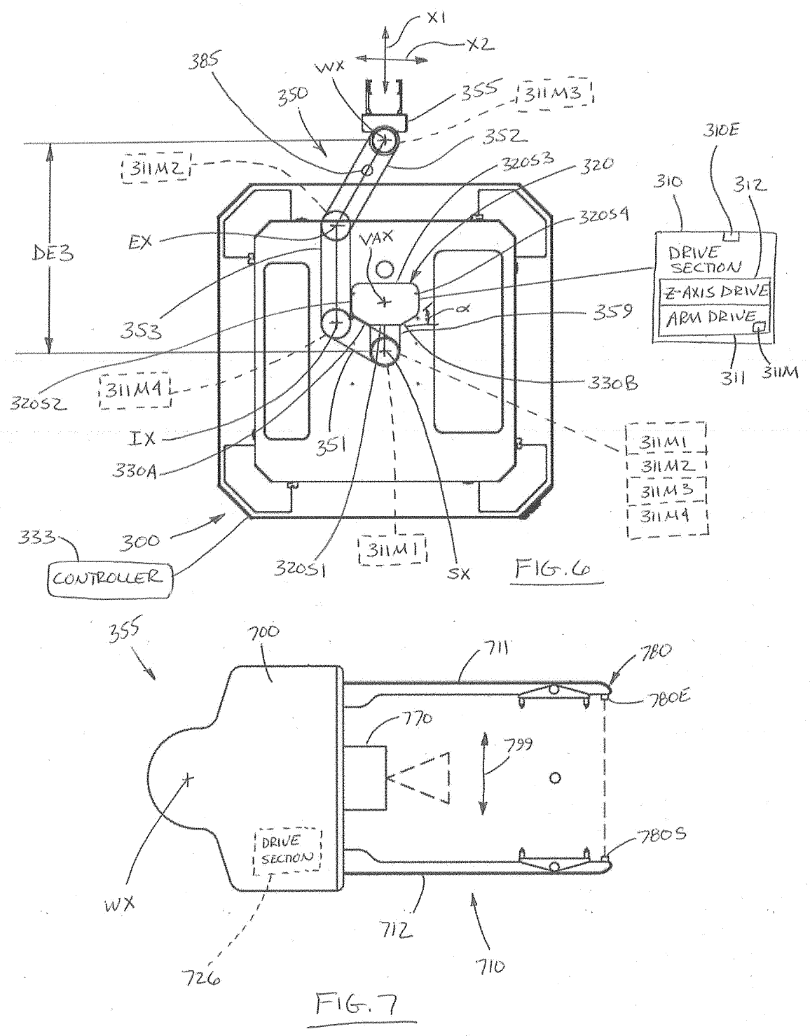

The labware transport apparatus 300 includes the arm 350, which is operably connected to the frame 301 by a drive section 310. The arm 350 is a selectably compliant arm having multiple arm links as described herein. Here the arm 350 has a predetermined arm link configuration that determines a minimum footprint (with the arm 350 in a retracted state) of the arm 350 and a corresponding maximum reach of the end effector 355 (with the arm 350 in an extended state) within a range of motion (described below) of the end effector 355. For example, the arm 350 includes an upper (or proximate) arm link 351, a forearm (or distal arm) link 352, and the end effector 355, where the upper arm 351, the forearm 352, and the end effector 355 are serially coupled to each other. The upper arm 351 is coupled to the drive section 310 for rotation about a shoulder (or proximate) axis of rotation SX. The forearm 352 is rotatably coupled to the upper arm 351 about an elbow (or distal) axis of rotation EX. The end effector 355 is coupled to the forearm 352 about a wrist axis of rotation WX. While the arm 350 is illustrated in FIGS. 3A and 3B as a two link arm with the end effector 355, the arm 350 may have more (or less) than two arm links that support the end effector 355 (which may also be referred to as an arm link, in which case the arm 350 is a three link arm) and the arm links may be of the same or differing lengths (e.g., from joint center to joint center) compared to each other. For example, referring to FIG. 6 the arm 350 may be a three link arm with an end effector 355 (which may also be referred to as an arm link, in which case the arm 350 is a four link arm) that includes a proximate arm link 351, an intermediate arm link 353, a distal arm link 352, and an end effector 355. Here the proximate arm link 351 may be shorter (e.g., from joint center to joint center) than one or more of the intermediate arm link 353 and the distal arm link 352, while in other aspects each of the proximate arm link 351, the intermediate arm link 353, and the distal arm link 352 may have any suitable relative lengths.

Still referring to FIGS. 3A, 3B, and 6, the drive section 310 is coupled to a controller 333 of the labware transport apparatus 300 in any suitable manner (e.g., wired or wirelessly). The controller 333 is configured to (e.g., with any suitable non-transitory computer program code) control operation of the drive section 310 to effect movement of the labware transport apparatus 300 as described herein. The drive section 310 includes an arm drive 311 disposed to extend and retract the arm 350 so as to extend and retract the end effector 355 in the labware space LBS along an extension axis X1, and displace the end effector 355 side to side along a transverse axis X2 angled relative to the extension axis X1. The extension axis X1 and the transverse axis X2, angled thereto, define the range of motion of the end effector 355 of the arm 350. The range of motion is in a level plane LP (where the range of motion may be referred to herein as a level range of motion), where the level plane LP, as described herein, may be moved in elevation along the substantially vertical axis of motion (also referred to herein as a Z-axis) VAX of the drive section 310. The level range of motion, at least in part of a labware space LBS, of the end effector 355 is determined by extension of a shape formed by a substantially upright axis of motion (e.g., Z-axis) VAX of the drive section 310, through the level range of motion (as described herein), and the shape has a configuration based on and disposed so as to maximize the level range of motion of the end effector 355 of the arm 350 having a predetermined link configuration that is common determining a minimum foot print MFP of the arm 350 in a retracted state of the arm 350 (e.g., with the arm links substantially folded one over the other—see FIG. 3C) and a corresponding maximum reach of the arm 350 in an extended state of the arm 350 (e.g., as described herein with respect to FIGS. 4-6).

The arm drive 311 includes at least one motor 311M (and suitable transmissions such as belt and pulley, direct drive shaft couplings, etc.) coupled to one or more of the upper arm 351, forearm 352, and end effector 355 for moving the end effector 355 along the extension axis X1 and transverse axis X2. For example, with respect to the arm 350 having the upper arm link 351, the forearm link 352, and the end effector 355, the at least one motor 311M includes a motor 311M1 for driving rotation of the upper arm 351 about the shoulder axis SX, a motor 311M2 for driving rotation of the forearm 352 about the elbow axis EX, and a motor 311M3 for driving rotation of the end effector 355 about the wrist axis WX. In one aspect, the motors 311M1, 311M2, 311M3 may be disposed side-by-side or coaxially within an arm support base or platform 359, from which the arm 350 is cantilevered, where the motors 311M1, 311M2, 311M3 are coupled to a respective one of the upper arm 351, forearm 352, and end effector 355 by any suitable transmission, such as those described herein. In other aspects, the motors 311M1, 311M2, 311M3 may be distributed on the arm 350 where, for example, motor 311M1 is located at or adjacent the shoulder axis SX for driving rotation of the upper arm 351, motor 311M2 is located at or adjacent the elbow axis EX for driving rotation of the forearm 352, and motor 311M3 is located at or adjacent the wrist axis WX for driving rotation of the end effector 355. In still other aspects, the motors 311M1, 311M2, 311M3 may be distributed about the labware transport apparatus 300 in any suitable manner for driving rotation of the upper arm 351, forearm 352, and end effector 355.

Similarly, with respect to the arm 350 having the proximate arm link 351, the intermediate arm link 353, the distal arm link 352, and the end effector 355, the at least one motor 311M includes a motor 311M1 for driving rotation of the proximate arm link 351 about the proximate axis SX, a motor 311M4 for driving rotation of the intermediate arm link 353 about an intermediate axis IX, a motor 311M2 for driving rotation of the distal arm link 352 about the distal axis EX, and a motor 311M3 for driving rotation of the end effector 355 about the wrist axis WX. In one aspect, the motors 311M1, 311M2, 311M3, 311M4 may be disposed side-by-side or coaxially within an arm support base or platform 359, from which the arm 350 is cantilevered, where the motors 311M1, 311M2, 311M3, 311M4 are coupled to a respective one of the proximate arm link 351, intermediate arm link 353, distal arm link 352, and end effector 355 by any suitable transmission, such as those described herein. In other aspects, the motors 311M1, 311M2, 311M3, 311M4 may be distributed on the arm 350 where, for example, motor 311M1 is located at or adjacent the proximate axis SX for driving rotation of the proximate arm link 351, motor 311M4 is located at or adjacent the intermediate axis IX for driving rotation of the intermediate arm link 353, motor 311M2 is located at or adjacent the distal axis EX for driving rotation of the distal arm link 352, and motor 311M3 is located at or adjacent the wrist axis WX for driving rotation of the end effector 355. In still other aspects, the motors 311M1, 311M2, 311M3, 311M4 may be distributed about the labware transport apparatus 300 in any suitable manner for driving rotation of the proximate arm link 351, intermediate arm link 353, distal arm link 352, and end effector 355.

It is noted that while each of the upper arm 351, forearm 352, and end effector 355 are described as being independently rotatable relative to each other, in some aspects one or more of the forearm 352 and end effector 355 may be slaved in rotation to another one of the arm links to effect movement of the end effector along the extension axis X1 and transverse axis X2. Similarly, while each of proximate arm link 351, intermediate arm link 353, distal arm link 352, and end effector 355 are described as being independently rotatable relative to each other, in some aspects one or more of the intermediate arm link 353, distal arm link 352, and end effector 355 may be slaved in rotation to another one of the arm links to effect movement of the end effector along the extension axis X1 and transverse axis X2.

Referring again to FIGS. 3A and 3B (noting the description of FIGS. 3A and 3B apply equally to FIG. 6), as described above, the arm 350 is supported by platform 359. The platform 359 is movably coupled to the frame 301 for movement along the Z-axis VAX. For example, the frame 301 forms a fixed (or otherwise stationary, i.e., non-rotatable) housing 320 that houses one or more linear rails or tracks 321 along which a carriage 322 is configured to move along the Z-axis VAX (e.g., the one or more linear rails define the Z-axis VAX). The housing 320 is a column 320C that rises or extends through the range of motion of the end effector 355. The drive section 310 includes a Z axis drive 312 (e.g., linear actuator, screw drive, etc.) that is coupled to the carriage 322 for moving the carriage 322 along the one or more rails 321. The platform 359 is coupled to or integrally formed with the carriage 322 so that as the carriage 322 is driven along the Z-axis VAX the arm 350 (and the level plane LP of the end effector 355 range of motion) moves along the Z-axis VAX with the carriage 322.

As noted above, the housing 320 extends through the range of motion (which is a level range of motion) of the end effector 355 such that the Z-axis VAX of the drive section 310 housed by the housing 320 forms a blockage within the range of motion. Here, the blockage is formed by the housing 320 and the housing forms an interference to arm motion within the range of motion of the end effector 355, where the range of motion, at least in part of the labware space LBS, of the end effector 355 is delimited by the blockage (e.g., the Z-axis VAX of the drive section 310 housed by the housing 320). For example, the blockage delimits arm motion traversing the end effector 355 on the transverse axis X2, or on the extension axis X1 of the range of motion. Here, the blockage/housing 320 interferes with at least one of extension motion (along extension axis X1) and transverse motion (along transverse axis X2) of at least one link (e.g., one or more of the upper arm 351, forearm 352, and end effector 355 or one or more of the proximate arm link 351, the intermediate arm link 353, the distal arm link 352, and the end effector 355—see also FIGS. 4-6) of the arm 350.

Referring to FIGS. 3A and 4-6, the housing 320 and the Z-axis VAX housed therein is sized and shaped based on and so as to maximize the range of motion of the end effector 355 of the arm 350 having the predetermined link configuration that is common in determining the minimum foot print and the corresponding maximum reach of the arm 350. As can be seen in FIG. 3A (see also FIGS. 4-6), the housing 320 has as at least one side chamfer 330A, 330B sized so as to minimize a dimension of the housing 320 within the range of motion and correspondingly increase, with the side chamfer 330A, 330B, freedom of movement of the arm 350 in the range of motion and maximize the range of motion. The dimension of the housing 320 that is minimized is a length LPL1, LPL2, of one or more of the substantially vertical sides, that extends in a direction substantially parallel with the level plane LP. FIGS. 4-6 illustrate exemplary housing sizes/shapes and arm configurations that provide for a predetermined range of motion of the end effector 355 as described herein.

In FIG. 4 the arm 350 having the upper arm 351, forearm 352, and end effector 355 is movably mounted to the housing 320 in the manner described herein. As can be seen in FIG. 4, the arm 350 has a shoulder axis SX that is fixed (e.g., at a predetermined stationary location with respect to the level plane LP but free to move along the Z-axis VAX) and offset (e.g., by distance DX) from the housing 320 (or blockage formed by the housing). The housing 320 (which is stationary and does not rotate relative to the frame 301) is sized and shaped so that chamfers 330A, 330B of the housing 320 reduce the lengths of sides 320S1, 320S2, 320S4 of the housing 320 to provide the arm 350 with a range of motion that extends on a side 320S3 of the housing 320 opposite the shoulder axis SX around the blockage formed by the housing 320. In this example, the chamfers 330A, 330B are arranged, relative to side 320S1 of the housing 320, at an angle α which is about 30°, although in other examples the angle α may be more or less than about 30°. It is noted that the distance DX may depend on the angle α of the chamfer 330A, 330B so that the upper arm link 351, at maximum extension of the end effector past side 320S3, is substantially parallel to and/or substantially abutting the chamfer 330A or the chamfer 330B, e.g., depending on which direction the upper arm 351 is rotated about the shoulder axis SX. As described herein, the substantially vertical axis of motion VAX of the housing 320 is fixed in a predetermined orientation (e.g., does not rotate to change an extension direction of the arm 350) and the transport of labware with the end effector is effected singularly via link articulation of the arm 350 in the range of motion of the end effector 355.

While the chamfers 330A, 330B illustrated in FIG. 4 effect a range of motion of the end effector 355 that extends past the opposite side 320S3 beyond the bounds of the frame 301, the range of motion may be decreased to within the bounds of the frame (e.g., where placement of labware within the bounds of the frame may occur) the closer the wrist axis WX gets to a centerline CL of the housing 320. It is noted that the extension distance of the end effector 355 past (lateral) sides 320S2, 320S4 and in front of side 320S1 may extend past the bounds of the frame 301 by a greater amount than the extension distance (e.g., see wrist axis extension distance DE) of the end effector 355 past the back side 320S3.

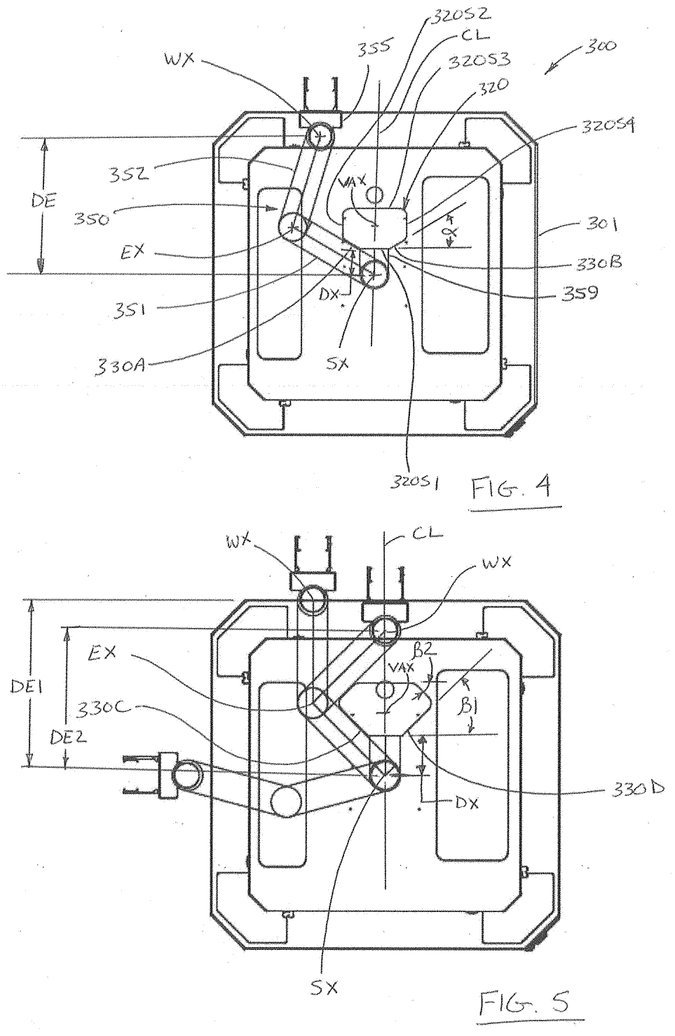

The housing 320 and offset (e.g., distance DX) configuration illustrated in FIG. 5 provides for a range of motion of the end effector 355 (e.g., carried by upper arm 351 and forearm 352) that extends past the opposite side/back 320S3 of the housing beyond the bounds of the frame 301 at the centerline CL as well away from (e.g., adjacent to) the centerline CL. Here, the arm 350 and housing 320 configuration illustrated in FIG. 5 may be referred to as a 360° access configuration (e.g., providing end effector 355 access to labware space throughout about 360° around the shoulder axis SX). For example, the housing 320 includes chamfers 330C, 330D adjacent the (front) side 320S1 and chamfers 330E, 330F adjacent the (back or opposite) side 320S3. As can be seen in FIG. 5, the arm 350 has the shoulder axis SX that is fixed (e.g., at a predetermined stationary location with respect to the level plane LP but free to move along the Z-axis VAX) and offset (e.g., by distance DX) from the housing 320. The housing 320 is sized and shaped so that chamfers 330C, 330D, 330E, 330F reduce the lengths of sides 320S1, 320S2, 320S3, 320S4 of the housing 320 to provide the arm 350 with a range of motion that extends on the back side 320S3 of the housing 320 opposite the shoulder axis SX around the blockage formed by the housing 320. In this example, the chamfers 330C, 330D are arranged, relative to side 320S1 of the housing 320, at an angle 131 which is about 45°, although in other examples the angle 131 may be more or less than about 45°. The chamfers 330E, 330F are arranged, relative to side 320S3 of the housing 320, at an angle 132 which is about 45°, although in other examples the angle 132 may be more or less than about 45°. The offset (e.g., distance DX at which the fixed location of the shoulder axis SX is located) is sized to provide maximum range of motion effecting end effector 355 access to labware space throughout about 360° (e.g., referred to herein as full range of motion) around the shoulder axis SX. It is noted that the distance DX may depend at least on the angle 131 of the chamfer 330C, 330D so that the upper arm link 351, at maximum extension of the end effector past side 320S3, is substantially parallel to and/or substantially abutting the chamfer 330C or the chamfer 330D, e.g., depending on which direction the upper arm 351 is rotated about the shoulder axis SX. It is noted that the angle 132 may depend on the joint center to joint center length of the upper arm 351 and the forearm 352 so that at maximum extension of the end effector along the centerline CL, the forearm 352 is substantially parallel with and/or substantially abutting the chamfer 330E or the chamfer 330F, e.g., depending on which direction the upper arm 351 is rotated about the shoulder axis SX. As described herein, the substantially vertical axis of motion VAX of the housing 320 is fixed in a predetermined orientation (e.g., does not rotate to change an extension direction of the arm 350) and the 360° access is effected singularly via link articulation of the arm 350 in the range of motion of the end effector 355.

While the chamfers 330C, 330D, 330E, 330F illustrated in FIG. 5 effect a range of motion that extends past the back side 320S3 beyond the bounds of the frame 301 at and adjacent the centerline CL of the housing 320 (to provide full range of motion0, the range of motion (e.g., amount of extension of the end effector 355 relative to the shoulder axis SX) may be decreased the closer the wrist axis WX gets to the centerline CL of the housing 320 (e.g., compare wrist axis extension distance DE1 away from the centerline CL with wrist axis extension distance DE2 at the centerline CL, where for exemplary purposes only extension distance DE1 (FIG. 4) is greater than extension distance DE and extension distance DE2 is substantially the same as extension distance DE, noting in other aspects the distance DE and distance DE2 may be different). It is noted that the extension distance of the end effector 355 past (lateral) sides 320S2, 320S4 and in front of side 320S1 may extend past the bounds of the frame 301 by a greater amount than the extension distance of the end effector 355 past the back side 320S3.

Referring to FIG. 6, the range of motion of the end effector 355 may be extended to beyond the bounds of the frame 301 past each of the sides 320S1-320S4 of the housing 320 regardless of whether the end effector 355 is placed on or along the centerline CL of the housing. Here, the arm 350, as described above, is provided with the proximate arm link 351, the intermediate arm link 353, the distal arm link 352, and the end effector 355. The housing 320 is also provided with chamfers 330A, 330B that are arranged relative to side 320S1 at the angle α. The distance DX of the proximate axis SX relative to the side 320S1 is such that at maximum extension of the end effector 355, past the back side 320S3 of the housing 320 and along the centerline CL of the housing 320, the proximate arm link 351 is substantially parallel with and/or substantially abutting the chamfer 330A or the chamfer 330B, e.g., depending on which direction the proximate arm link 351 is rotated about the proximate axis SX. The length of the proximate arm link 351 from joint center to joint center (e.g., between the proximate axis SX and the intermediate axis IX) is such that intermediate arm link 353 is substantially parallel with the side 320S2 or the side 320S4, e.g., depending on which direction the proximate arm link 351 is rotated about the proximate axis SX. Here the range of motion of the end effector 355 supported by the three arm links 351, 352, 353 is greater than the range of motion of the end effector 355 supported by the two arm links 351, 352 at and adjacent to the centerline CL past the side 320S3 of the housing 320 (as well as past the sides 320S2, 320S3 and in front of side 320S1), where the wrist axis extension distance DE3 is greater than wrist axis extension distances DE, DE1, DE2. Here, the arm 350 and housing 320 configuration illustrated in FIG. 6 may be referred to as a long reach 360° access configuration. As described herein, the substantially vertical axis of motion VAX of the housing 320 is fixed in a predetermined orientation (e.g., does not rotate to change an extension direction of the arm 350) and the 360° access is effected singularly via link articulation of the arm 350 in the range of motion of the end effector 355.

The aspects of the disclosed embodiment described above provide for placement of laboratory instruments, workpiece holding stations, and any other suitable instrumentation, processing, and/or storage equipment (such as those described herein) behind the arm 350, where such instrumentation, processing and/or storage equipment would not be reachable by the conventional labware transport robotics without rotation of the robotic arm as a unit about the vertical axis. Here the aspects of the disclosed embodiment provide for maximization of system instrument density (e.g., the number of devices that the arm 350 can reach) while decreasing complexity and cost of the labware transport apparatus 300 as described herein.

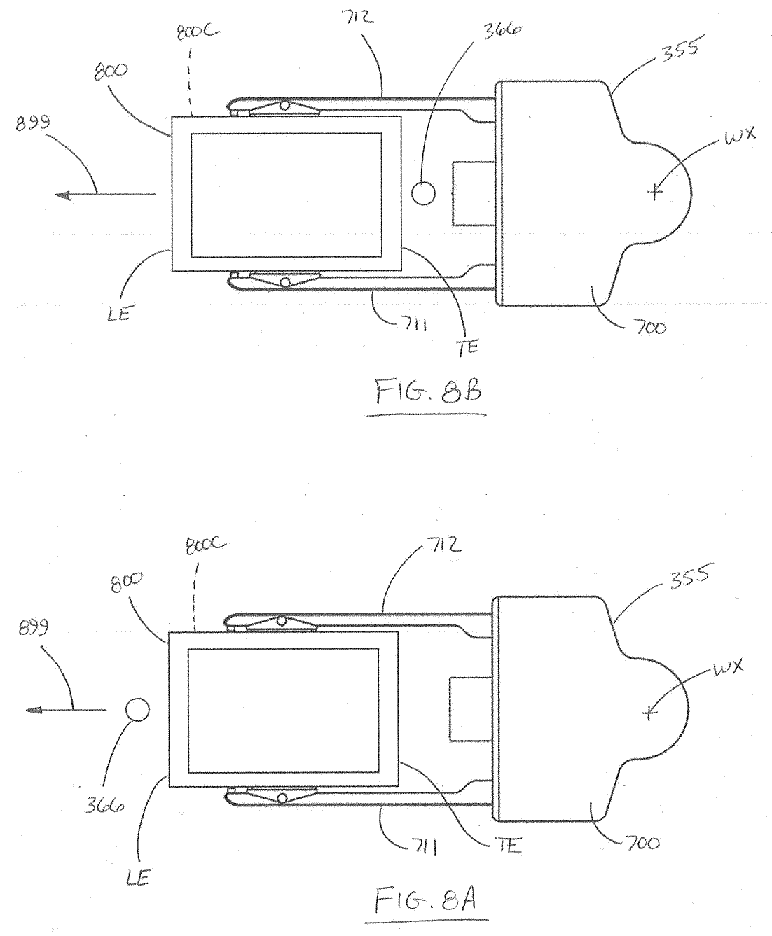

Referring to FIGS. 3A, 3B, and 7, the end effector 355 of the arm 350 may be any suitable end effector configured for transporting any suitable labware (e.g., multi-well plates, cassettes, vials, racks, pipetting trays, etc.). Suitable examples of end effectors that may be employed with the arm 350 are described in, for example, U.S. patent application Ser. No. 15/689,986 filed Aug. 29, 2017 (and published on Mar. 1, 2018 as United States pre-grant publication number 2018/0056528) and U.S. Pat. No. 11,045,811 issued on Jun. 29, 2021, the disclosures of which were previously incorporated herein by reference in their entireties.

Referring also to FIG. 7, the end effector 355 includes/is provided with a base portion 700 and workpiece grip 710 having labware engagement members 711, 712 that are configured to engage and hold labware, such as the labware described herein, during labware transport, such as by the arm motion in/along at least one of the extension axis X1, the transverse axis X2, and the Z-axis VAX. In one aspect, the labware engagement members 711, 712 are movably coupled to the base portion 700 so that at least one of the labware engagement members 711, 712 is movable, through activation of a drive section 726 (of the end effector 355), in direction 799 relative to each other and/or the base portion 700 for effecting the gripping and release of labware (e.g. the labware engagement members 711, 712 are active gripping members) while, in other aspects, the labware engagement members 711, 712 may be stationarily coupled to the base portion 700 for passively engaging the labware without relative movement between each other and/or the base portion 700 (e.g. the labware engagement members 711, 712 are passive griping members). While one or more of the workpiece engagement members 711, 712 are described as being configured for linear translation in direction 799, it should be understood that in other aspects the workpiece engagement members 711, 712 may be moved in any suitable manner relative to each other and/or the base portion 700 for gripping and releasing the labware. For example, the workpiece engagement members 611, 612 may be rotatably mounted to the base portion 600B for gripping and releasing the workpiece through a rotation of one or more of the workpiece engagement members 611, 612.

The end effector 355 may include any suitable labware scanner and/or labware presence detector that is/are coupled to the controller 333 in any suitable manner. For example, a bar code scanner 770 may be mounted to any suitable location of the base portion 700 so as to identify labware being picked or otherwise held by the end effector 355. A through beam sensor 780 may also be disposed on the end effector 355 for detecting a presence of labware stored in, for example, a storage carousel (or at any other suitable location of the processing systems described herein). In one aspect, the through beam sensor 780 may be disposed on the labware engagement members 711, 712 where an emitter 780E is disposed on one of the labware engagement members 711, 712 and a receiver 780S is disposed on the other of the labware engagement members 711, 712.

The through beam sensor 780 may be configured to determine if labware is present in labware holding locations of, for example, a random access storage rack module 140RA or other labware holding location so as to create a map of the labware at the labware holding location (e.g., which holding locations are holding labware and which location are not). The through beam sensor 780 may also be configured to determine (e.g., map) how many pieces of labware (such as sample holders) are stacked in a non-random storage rack modules 140N (such as a storage nest). For example, the through beam sensor 780 may be configured with a fast capture input/output that latches the encoder position on the Z-axis motor. The transition points between the individual pieces of labware are then filtered and compared to empty storage rack module 140 measurements to determine differences.

In one aspect, the through beam sensor 780 may also be latched to arm motor(s) 311M1-311M3, 311M1-311M4 (see FIGS. 3A and 6) positions (e.g., with any suitable encoders 310E) and can be used for auto-teaching labware holding locations to the different drive axes of the arm 350 (such as by determining a location of storage location features or a location of a special fiducials FD) to the controller 333 (Figs. of the arm 350. For example, referring to FIG. 1C, a location of storage nest 140N may be taught to controller 333 by detecting locations of corners CN of the storage nest 140N and/or a special fiducial FD (post, pin, slot, or other suitable detectable feature) of the storage nest 140N with the through beam sensor 780, which locations of the corners CN and/or special fiducial FD are in known locations relative to the holding locations of the storage nest 140N and are employed by the controller 333 to offset movements of the arm 350 for picking/placing labware from/to the storage nest 140N.

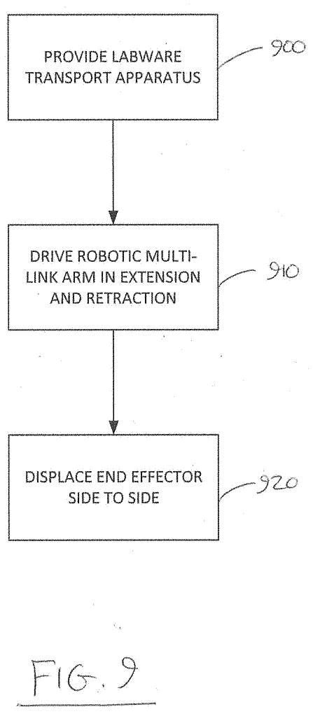

Referring to FIGS. 3A, 3B, 8A, and 8B the labware transport apparatus 300 is configured for automatic labware centering. The automatic (on-the-fly) labware centering will be described herein with respect to multi-well plate 800; however, automatic labware centering as described herein may be employed with any suitable labware having leading and trailing edges. The labware transport apparatus 300 includes one or more centering sensors 366 communicably coupled (e.g., wirelessly or wired) to the controller 333. The centering sensors 366 are disposed onboard the labware transport apparatus 300 and/or off-board the labware transport apparatus 300. With the centering sensors 366 located onboard the labware transport apparatus 300 the centering sensors 366 may be disposed at any suitable location on the labware transport apparatus 300 within the range of motion of the end effector 355, such as for example on the housing 320 (see FIG. 3A). With the centering sensors 366 located off-board the labware transport apparatus 300 the centering sensors 366 may be disposed at any suitable location within the range of motion of the end effector 355, such as for example on or adjacent a labware processing station 398 (such as those described herein). The centering sensors 366 may be any suitable sensors, such as optical sensors (through beam, reflective) or any other sensor configured to detect the leading edge and trailing edge of the labware as the labware is transported by the end effector 355 from an initial pick position to a destination place position. As an example, the centering sensors 366 may be reflective beam sensors 366R (FIG. 3A) where the beam transmitter and beam receiver are located adjacent one another in a common housing. As another example, the centering sensors 366 may be a through beam/break the beam sensor having a beam emitter 366E and a beam receiver 366S spaced from one another so that the end effector 355 moves the labware between the beam emitter 366E and beam receiver 366S. In other aspects, the centering sensors 366 may be cameras or other suitable optical or sonic sensor configured to effect detection of at least the leading and trailing edges of the labware. The centering sensors 366 may be configured with a fast capture input/output that latches encoder positions of the arm motors 311M1, 311M2, 311M3 or 311M1, 311M2, 311M3. 311M4 when the leading and trailing edges are sensed.

To effect centering of the labware the centering sensors 366 are calibrated with a calibration plate 800C (or other calibration fixture held by the end effector and having a form factor of the labware being processed) that is centered, e.g., such as by an operator, on the end effector 355 labware engagement members 711, 712. The arm 350 is operated to transport the calibration plate 800C in direction 899, within the range of motion of the end effector 355, past/through the sensor beam 366B (of the onboard and/or off-board centering sensors) so that the leading edge LE and trailing edge TR of the calibration plate 800C are detected and the arm motor 311M1, 311M2, 311M3 or 311M1, 311M2, 311M3, 311M4 encoder 310E positions corresponding to the detections (e.g., calibrated centered positions) are registered by the controller 333. With the centering sensors 366 calibrated, the arm 350 is operated to transport the multi-well plate 800 in direction 899, within the range of motion of the end effector 355, past/through the sensor beam 366B (of the onboard and/or off-board centering sensors) so that the leading edge LE and trailing edge TR of the multi-well plate 800 are detected and the arm motor 311M1, 311M2, 311M3 or 311M1, 311M2, 311M3, 311M4 encoder 310E positions corresponding to the detections of the leading and trailing edges LE, TE of the multi-well plate 800 are registered by the controller 333 and compared to the calibrated centered positions, such that any difference therebetween is employed by the controller 333 to offset the position of the end effector 355 to place the multi-well plate in a centered position at a labware holding location, such as storage rack module 140. Where more than one centering sensor 366 is employed (e.g., such as more than one onboard centering sensor, more than one off-board centering sensor, or a combination of onboard and off-board centering sensors) subsequent centering determinations may be provided to verify an initial/previous centering determination.

Referring to FIG. 3B, the arm 350 includes at least one object detection sensor 381-386 disposed on at least one arm link of the multi-link arm 350 so that the at least one object detection sensor 381-386 senses one or more of a labware pose (e.g., to effect a substantially centered picking of the labware), labware holding location pose (e.g., to effect a substantially centered placing of the labware), and obstructions (e.g., transient obstacles/objects OBJ within the range of motion of the end effector 355) located underneath or above the multi-link arm 350 along the substantially vertical axis of motion VAX. The at least one object detection sensor 381-386 is one or more of a ranging sensor (e.g., time-of-flight camera, stereo vision system, etc.), an optical sensor (e.g., camera or other vision system), an inductance sensor, a sonic sensor, millimeter wave radar (such as described in U.S. patent application Ser. No. 17/032,011 filed on Sep. 25, 2020 and titled “Robotic Transport System and Method Therefor,” the disclosure of which was previously incorporated herein by reference in its entirety), LIDAR (Light Detection and Ranging), and any other sensor configured to effect image analysis and/or ranging (e.g., distance determination from the arm 350) of objects within the range of motion of the end effector 355 and along the substantially vertical axis of motion VAX.

As illustrated in FIG. 3B, the at least one object detection sensor 381-386 comprises at least one object detection sensor disposed on each arm link (e.g., the upper arm 351, the forearm 352, and the end effector 355); however, in other aspects the object detection sensors 381-386 may be disposed on one arm link or more than one arm link. It is also noted that four-link arm illustrated in FIG. 6 may include one or more object detection sensors on one or more of the arm links (e.g. the proximate arm link 351, the intermediate arm link 353, the distal arm link 352, and the end effector 355) in a manner similar to that described herein. Each of the at least one object detection sensor 381-386 has a respective field of view FOV1-FOV6 extending along the substantially vertical axis of motion VAX and is configured to sense one or more of the labware pose (e.g., orientation of the labware within the level range of motion), the labware holding location pose (e.g., orientation of the labware holding location within the level range of motion), and transient obstructions/objects OBJ located one or more of underneath and above the multi-link arm 350 along the substantially vertical axis of motion VAX. To sense obstructions located above the arm 350 at least one of the upper arm 351, the forearm 352, and the end effector 355 (and intermediate link 353 with reference to FIG. 6) includes at least one upward facing object detection sensor 384-386. To sense obstructions and labware/holding location poses located below the arm 350 at least one of the upper arm 351, the forearm 352, and the end effector 355 (and intermediate link 353 with reference to FIG. 6) includes at least one downward facing object detection sensor 381-383.

In accordance with aspects of the disclosed embodiment, a common sensor(s) (e.g., one or more of the at least one object detection sensor 381-386) is/are configured to detect both the transient obstacles and labware/holding location poses (e.g., to effect labware centering for picking and placing the labware). For example, the controller 333 is coupled to the at least one object detection sensor 381-386. The controller 333 is configured to, based on input from the at least one object detection sensor 381-386, offset a position of the robotic multi-link arm 350 within the range of motion to effect one or more of picking and placing of labware within the range of motion so that when picked the labware is centered on the end effector 355 and when placed the labware (previously centered on the end effector at picking of the labware) is centered at the holding location. For example, picking of labware may include, with the object detection sensors 381-386 and controller 333, sensing and determining (e.g., through optical/image/point cloud analysis, etc.) the pose of the labware to be picked. Based on the pose of the labware relative to a coordinate system of the arm 350, the controller 333 manipulates the arm 350 to pick the labware so that the labware is centered on the labware engagement members 711, 712. Similarly, with the labware centered on the labware engagement members 711, 712, placing of labware may include, with the object detection sensors 381-386 and controller 333, sensing and determining (e.g., through optical/image/point cloud analysis, etc.) the pose of the labware holding location at which the labware is to be placed. Based on the pose of the labware holding location relative to a coordinate system of the arm 350, the controller 333 manipulates the arm 350 to place the labware so that the labware is centered at the labware holding location. The controller 333 is also configured to, based on input from the at least one object detection sensor 381-386 (which object detection sensors are common to labware centering), slow or stop motion of the arm 350, as described herein, along the substantially vertical axis of motion VAX with a transient obstruction/object OBJ within a substantially vertical movement path (e.g., upward or downward along the substantially vertical axis of motion VAX) of the arm 350 so that the above-noted exemplary standards may be met.

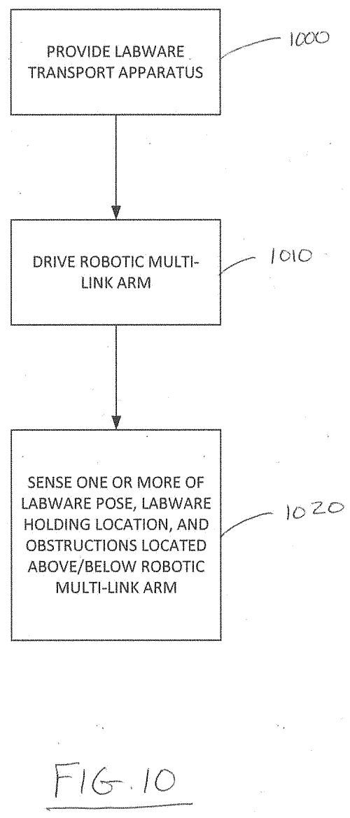

Referring now to FIGS. 3A-6 and 9 an exemplary method will be described in accordance with aspects of the disclosed embodiment. The method includes providing the labware transport apparatus 300 described herein (FIG. 9, Block 900). The robotic arm 350 is driven with the drive section 310 so as to extend and retract the end effector 355 of the arm 350 in the labware space LBS along the extension axis X1 (FIG. 9, Block 910). The drive section 310 is operated to displace the end effector 355 side to side along the transverse axis X2 (FIG. 9, Block 920) angled relative to the extension axis, where the extension axis and transverse axis angled thereto define a level range of motion of the end effector of the robotic multi-link arm. As described herein, the arm 350 has a predetermined link configuration determining a minimum footprint MFP (FIG. 3C) of the robotic multi-link arm 350 and a corresponding maximum reach of the end effector 355 within the level range of motion. The drive section 310 drives the arm 350 between the minimum footprint MFP and the maximum extension within the range of motion of the end effector 355 with traverse of the end effector 355 along one or more of the extension axis X1 and the transverse axis X2. The range of motion (e.g., the level range of motion), at least in part of the labware space LBS, of the end effector 355 is determined by extension of a shape formed by the substantially upright axis of motion VAX of the drive section 310, through the level range of motion. As described herein the shape has a configuration based on and disposed so as to maximize the level range of motion of the end effector 355 of the robotic multi-link arm 350 having the predetermined link configuration that is common determining the minimum foot print and the corresponding maximum reach.

Referring now to FIGS. 3A-6 and 10 an exemplary method will be described in accordance with aspects of the disclosed embodiment. The method includes providing the labware transport apparatus 300 described herein (FIG. 10, Block 1000). The robotic arm 350 is driven with the drive section 310 so as to extend and retract an end effector 355 of the robotic multi-link arm 350 in the labware space LBS along the extension axis X1, and displace the end effector side to side along the transverse axis X2 angled relative to the extension axis (FIG. 10, Block 1010). The at least one sensor 381-386, disposed on the robotic multi-link arm 350 (as described herein), senses one or more of a labware pose, labware holding location pose, and obstructions located one or more of underneath and above the multi-link arm along the substantially vertical axis of motion VAX (FIG. 10, Block 1020), where each of the at least one sensor 381-386 has a field of view FOV1-FOV6 extending along the substantially vertical axis of motion VAX. A position of the robotic multi-link arm 350 within the range of motion is offset, based on input from the at least one sensor 381-386 to the controller 333, to effect one or more of picking and placing of labware (such as, e.g., multi-well plate 800 or other suitable labware described herein) within the range of motion of the end effector 355. Motion of the arm 350 may also be slowed or stopped along the substantially vertical axis of motion VAX, based on input (e.g., transient object detection) from the at least one sensor 381-386 to the controller 333, with an obstruction (such as a transient object OBJ) within a substantially vertical movement path of the robotic multi-link arm 350.

In accordance with one or more aspects of the disclosed embodiment a labware transport apparatus comprises:

a frame defining a labware space; and

a robotic multi-link arm, articulated so that the robotic multi-link arm is selectably compliant, the robotic multi-link arm is operably connected to the frame, via a drive section, disposed to extend and retract the robotic multi-link arm so as to extend and retract an end effector of the robotic multi-link arm in the labware space along an extension axis, and displace the end effector side to side along a transverse axis angled relative to the extension axis, the extension axis and transverse axis angled thereto define a range of motion of the end effector of the robotic multi-link arm;

wherein the robotic multi-link arm has a predetermined link configuration determining a minimum footprint of the robotic multi-link arm and a corresponding maximum reach of the end effector within the range of motion; and

wherein the range of motion, at least in part of the labware space, of the end effector is delimited by a blockage of a substantially vertical axis of motion, of the drive section, extending through the range of motion, wherein the blockage is sized and shaped based on and so as to maximize the range of motion of the end effector of the robotic multi-link arm having the predetermined link configuration that is common determining the minimum foot print and the corresponding maximum reach.

In accordance with one or more aspects of the disclosed embodiment the blockage delimits arm motion traversing the end effector on the transverse axis, or on the extension axis of the range of motion.

In accordance with one or more aspects of the disclosed embodiment the blockage interferes with at least one of extension and transverse motion of at least one link of the multi-link arm.

In accordance with one or more aspects of the disclosed embodiment the blockage is formed by a housing of the substantially vertical axis of motion, and the housing forms an interference to arm motion within the range of motion.

In accordance with one or more aspects of the disclosed embodiment the housing has as a side chamfer sized so as to minimize a dimension of the housing within the range of motion and correspondingly increase, with the side chamfer, freedom of movement of the robotic multi-link arm in the range of motion and maximize the range of motion.

In accordance with one or more aspects of the disclosed embodiment the housing is a column rising through the range of motion.

In accordance with one or more aspects of the disclosed embodiment the robotic multi-link arm has a shoulder axis that is fixed and offset from the housing, and the offset is sized to provide maximum range of motion effecting end effector access to labware space throughout about 360° around the shoulder axis.

In accordance with one or more aspects of the disclosed embodiment the substantially vertical axis of motion is fixed in a predetermined orientation and 360° access is effected singularly via link articulation of the robotic multi-link arm in the range of motion.

In accordance with one or more aspects of the disclosed embodiment the labware transport apparatus further comprises at least one sensor disposed on at least one arm link of the multi-link arm so that the sensor senses one or more of a labware pose, labware holding location pose, and obstructions located underneath or above the multi-link arm.

In accordance with one or more aspects of the disclosed embodiment the at least one sensor is a ranging sensor.

In accordance with one or more aspects of the disclosed embodiment a labware transport apparatus comprises:

a frame defining a labware space; and

a robotic multi-link arm, articulated so that the robotic multi-link arm is selectably compliant, the robotic multi-link arm is operably connected to the frame, via a drive section, disposed to extend and retract the robotic multi-link arm so as to extend and retract an end effector of the robotic multi-link arm in the labware space along an extension axis, and displace the end effector side to side along a transverse axis angled relative to the extension axis, the extension axis and transverse axis angled thereto define a level range of motion of the end effector of the robotic multi-link arm;

wherein the robotic multi-link arm has a predetermined link configuration determining a minimum footprint of the robotic multi-link arm and a corresponding maximum reach of the end effector within the level range of motion; and

wherein the level range of motion, at least in part of the labware space, of the end effector is determined by extension of a shape formed by a substantially upright axis of motion of the drive section, through the level range of motion, and the shape has a configuration based on and disposed so as to maximize the level range of motion of the end effector of the robotic multi-link arm having the predetermined link configuration that is common determining the minimum foot print and the corresponding maximum reach.

In accordance with one or more aspects of the disclosed embodiment the substantially upright axis of motion delimits arm motion traversing the end effector on the transverse axis, or on the extension axis of the range of motion.

In accordance with one or more aspects of the disclosed embodiment the substantially upright axis of motion interferes with at least one of extension and transverse motion of at least one link of the multi-link arm.

In accordance with one or more aspects of the disclosed embodiment the substantially upright axis of motion comprises a housing, and the housing forms an interference to arm motion within the level range of motion.

In accordance with one or more aspects of the disclosed embodiment the housing has as a side chamfer sized so as to minimize a dimension of the housing within the level range of motion and correspondingly increase, with the side chamfer, freedom of movement of the robotic multi-link arm in the level range of motion and maximize the level range of motion.

In accordance with one or more aspects of the disclosed embodiment the housing is a column rising through the level range of motion.

In accordance with one or more aspects of the disclosed embodiment the robotic multi-link arm has a shoulder axis that is fixed and offset from the housing, and the offset is sized to provide maximum range of motion effecting end effector access to labware space throughout about 360° around the shoulder axis.

In accordance with one or more aspects of the disclosed embodiment the substantially upright axis of motion is fixed in a predetermined orientation and 360° access is effected singularly via link articulation of the robotic multi-link arm in the level range of motion.

In accordance with one or more aspects of the disclosed embodiment the labware transport apparatus further comprises at least one sensor disposed on at least one arm link of the multi-link arm so that the sensor senses one or more of a labware pose, labware holding location pose, and obstructions located underneath or above the multi-link arm.

In accordance with one or more aspects of the disclosed embodiment the at least one sensor is a ranging sensor.

In accordance with one or more aspects of the disclosed embodiment a method comprises:

providing a labware transport apparatus with

a frame defining a labware space, and

a robotic multi-link arm, articulated so that the robotic multi-link arm is selectably compliant, the robotic multi-link arm is operably connected to the frame, via a drive section;

driving the robotic multi-link arm with the drive section so as to extend and retract an end effector of the robotic multi-link arm in the labware space along an extension axis; and

displacing, with the drive section, the end effector side to side along a transverse axis angled relative to the extension axis, where the extension axis and transverse axis angled thereto define a level range of motion of the end effector of the robotic multi-link arm;

wherein: the robotic multi-link arm has a predetermined link configuration determining a minimum footprint of the robotic multi-link arm and a corresponding maximum reach of the end effector within the level range of motion, and the level range of motion, at least in part of the labware space, of the end effector is determined by extension of a shape formed by a substantially upright axis of motion of the drive section, through the level range of motion, and the shape has a configuration based on and disposed so as to maximize the level range of motion of the end effector of the robotic multi-link arm having the predetermined link configuration that is common determining the minimum foot print and the corresponding maximum reach.

In accordance with one or more aspects of the disclosed embodiment the substantially upright axis of motion delimits arm motion traversing the end effector on the transverse axis, or on the extension axis of the range of motion.

In accordance with one or more aspects of the disclosed embodiment the substantially upright axis of motion interferes with at least one of extension and transverse motion of at least one link of the multi-link arm.

In accordance with one or more aspects of the disclosed embodiment the substantially upright axis of motion comprises a housing, and the housing forms an interference to arm motion within the level range of motion.

In accordance with one or more aspects of the disclosed embodiment a side chamfer of the housing is sized so as to minimize a dimension of the housing within the level range of motion and correspondingly increase, with the side chamfer, freedom of movement of the robotic multi-link arm in the level range of motion and maximize the level range of motion.

In accordance with one or more aspects of the disclosed embodiment the housing is a column rising through the level range of motion.

In accordance with one or more aspects of the disclosed embodiment a shoulder axis of the robotic multi-link arm is fixed and offset from the housing, and the offset is sized to provide maximum range of motion effecting end effector access to labware space throughout about 360° around the shoulder axis.

In accordance with one or more aspects of the disclosed embodiment the substantially upright axis of motion is fixed in a predetermined orientation and 360° access is effected singularly via link articulation of the robotic multi-link arm in the level range of motion.

In accordance with one or more aspects of the disclosed embodiment the method further comprises sensing, with at least one sensor disposed on at least one arm link of the multi-link arm, one or more of a labware pose, labware holding location pose, and obstructions located underneath or above the multi-link arm.

In accordance with one or more aspects of the disclosed embodiment the at least one sensor is a ranging sensor.

In accordance with one or more aspects of the disclosed embodiment a labware transport apparatus comprises:

a frame defining a labware space;

a drive section coupled to the frame and having a substantially vertical axis of motion;

a robotic multi-link arm coupled to the substantially vertical axis of motion for substantially vertical movement of the robotic multi-link arm within the labware space, where the drive section is disposed to extend and retract the robotic multi-link arm so as to extend and retract an end effector of the robotic multi-link arm in the labware space along an extension axis, and displace the end effector side to side along a transverse axis angled relative to the extension axis, the extension axis and transverse axis angled thereto define a range of motion of the end effector of the robotic multi-link arm; and

at least one sensor disposed on the robotic multi-link arm, each of the at least one sensor having a field of view extending along the substantially vertical axis of motion and being configured to sense one or more of a labware pose, labware holding location pose, and obstructions located one or more of underneath and above the multi-link arm along the substantially vertical axis of motion.

In accordance with one or more aspects of the disclosed embodiment the labware transport apparatus further comprises a controller coupled to the at least one sensor, the controller being configured to, based on input from the at least one sensor, offset a position of the robotic multi-link arm within the range of motion to effect one or more of picking and placing of labware within the range of motion.

In accordance with one or more aspects of the disclosed embodiment the labware transport apparatus further comprises a controller coupled to the at least one sensor, the controller being configured to, based on input from the at least one sensor, slow or stop motion of the robotic multi-link arm along the substantially vertical axis of motion with an obstruction within a substantially vertical movement path of the robotic multi-link arm.

In accordance with one or more aspects of the disclosed embodiment the at least one sensor comprises one or more of a ranging sensor, an optical sensor, an inductance sensor, and a sonic sensor.

In accordance with one or more aspects of the disclosed embodiment the robotic multi-link arm has a predetermined link configuration determining a minimum footprint of the robotic multi-link arm and a corresponding maximum reach of the end effector within the range of motion; and the range of motion, at least in part of the labware space, of the end effector is delimited by a blockage of the substantially vertical axis of motion, of the drive section, extending through the range of motion, wherein the blockage is sized and shaped based on and so as to maximize the range of motion of the end effector of the robotic multi-link arm having the predetermined link configuration that is common determining the minimum foot print and the corresponding maximum reach.

In accordance with one or more aspects of the disclosed embodiment the blockage delimits arm motion traversing the end effector on the transverse axis, or on the extension axis of the range of motion.

In accordance with one or more aspects of the disclosed embodiment the blockage interferes with at least one of extension and transverse motion of at least one link of the multi-link arm.

In accordance with one or more aspects of the disclosed embodiment the blockage is formed by a housing of the substantially vertical axis of motion, and the housing forms an interference to arm motion within the range of motion.

In accordance with one or more aspects of the disclosed embodiment the housing has as a side chamfer sized so as to minimize a dimension of the housing within the range of motion and correspondingly increase, with the side chamfer, freedom of movement of the robotic multi-link arm in the range of motion and maximize the range of motion.

In accordance with one or more aspects of the disclosed embodiment the housing is a column rising through the range of motion.

In accordance with one or more aspects of the disclosed embodiment the robotic multi-link arm has a shoulder axis that is fixed and offset from the housing, and the offset is sized to provide maximum range of motion effecting end effector access to labware space throughout about 360° around the shoulder axis.

In accordance with one or more aspects of the disclosed embodiment the substantially vertical axis of motion is fixed in a predetermined orientation and 360° access is effected singularly via link articulation of the robotic multi-link arm in the range of motion.

In accordance with one or more aspects of the disclosed embodiment a method comprises:

providing a labware transport apparatus with:

a frame defining a labware space,

a drive section coupled to the frame and having a substantially vertical axis of motion, and

a robotic multi-link arm coupled to the substantially vertical axis of motion for substantially vertical movement of the robotic multi-link arm within the labware space

driving the robotic multi-link arm with the drive section so as to extend and retract an end effector of the robotic multi-link arm in the labware space along an extension axis, and displace the end effector side to side along a transverse axis angled relative to the extension axis, the extension axis and transverse axis angled thereto define a range of motion of the end effector of the robotic multi-link arm; and

sensing, with at least one sensor disposed on the robotic multi-link arm, one or more of a labware pose, labware holding location pose, and obstructions located one or more of underneath and above the multi-link arm along the substantially vertical axis of motion, where each of the at least one sensor has a field of view extending along the substantially vertical axis of motion.

In accordance with one or more aspects of the disclosed embodiment the method further comprises offsetting, based on input from the at least one sensor to a controller, a position of the robotic multi-link arm within the range of motion to effect one or more of picking and placing of labware within the range of motion.

In accordance with one or more aspects of the disclosed embodiment the method further comprises, based on input from the at least one sensor to a controller, slowing or stopping motion of the robotic multi-link arm along the substantially vertical axis of motion with an obstruction within a substantially vertical movement path of the robotic multi-link arm.

In accordance with one or more aspects of the disclosed embodiment the at least one sensor comprises one or more of a ranging sensor, an optical sensor, an inductance sensor, and a sonic sensor.

In accordance with one or more aspects of the disclosed embodiment the robotic multi-link arm has a predetermined link configuration determining a minimum footprint of the robotic multi-link arm and a corresponding maximum reach of the end effector within the range of motion; and the range of motion, at least in part of the labware space, of the end effector is delimited by a blockage of the substantially vertical axis of motion, of the drive section, extending through the range of motion, wherein the blockage is sized and shaped based on and so as to maximize the range of motion of the end effector of the robotic multi-link arm having the predetermined link configuration that is common determining the minimum foot print and the corresponding maximum reach.

In accordance with one or more aspects of the disclosed embodiment the blockage delimits arm motion traversing the end effector on the transverse axis, or on the extension axis of the range of motion.

In accordance with one or more aspects of the disclosed embodiment the blockage interferes with at least one of extension and transverse motion of at least one link of the multi-link arm.

In accordance with one or more aspects of the disclosed embodiment the blockage is formed by a housing of the substantially vertical axis of motion, and the housing forms an interference to arm motion within the range of motion.

In accordance with one or more aspects of the disclosed embodiment the housing has as a side chamfer sized so as to minimize a dimension of the housing within the range of motion and correspondingly increase, with the side chamfer, freedom of movement of the robotic multi-link arm in the range of motion and maximize the range of motion.

In accordance with one or more aspects of the disclosed embodiment the housing is a column rising through the range of motion.

In accordance with one or more aspects of the disclosed embodiment the robotic multi-link arm has a shoulder axis that is fixed and offset from the housing, and the offset is sized to provide maximum range of motion effecting end effector access to labware space throughout about 360° around the shoulder axis.

In accordance with one or more aspects of the disclosed embodiment the substantially vertical axis of motion is fixed in a predetermined orientation and 360° access is effected singularly via link articulation of the robotic multi-link arm in the range of motion.

It should be understood that the foregoing description is only illustrative of the aspects of the disclosed embodiment. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the disclosed embodiment.

What is claimed is:

1. A labware transport apparatus comprising:
a frame defining a labware space; and
a robotic multi-link arm, articulated so that the robotic multi-link arm is selectably compliant, the robotic multi-link arm is operably connected to the frame, via a drive section, disposed to extend and retract the robotic multi-link arm so as to extend and retract an end effector of the robotic multi-link arm in the labware space along an extension axis, and displace the end effector side to side along a transverse axis angled relative to the extension axis, the extension axis and transverse axis angled thereto define a range of motion of the end effector of the robotic multi-link arm;
wherein the robotic multi-link arm has a predetermined link configuration determining a minimum footprint of the robotic multi-link arm and a corresponding maximum reach of the end effector within the range of motion; and
wherein the range of motion, at least in part of the labware space, of the end effector is delimited by a blockage of a substantially vertical axis of motion, of the drive section, extending through the range of motion, wherein the blockage is sized and shaped based on and so as to maximize the range of motion of the end effector of the robotic multi-link arm having the predetermined link configuration that is common determining the minimum foot print and the corresponding maximum reach.

2. The labware transport apparatus of claim 1, wherein the blockage delimits arm motion traversing the end effector on the transverse axis, or on the extension axis of the range of motion.

3. The labware transport apparatus of claim 1, wherein the blockage interferes with at least one of extension and transverse motion of at least one link of the multi-link arm.

4. The labware transport apparatus of claim 1, wherein the blockage is formed by a housing of the substantially vertical axis of motion, and the housing forms an interference to arm motion within the range of motion.

5. The labware transport apparatus of claim 4, wherein the housing has as a side chamfer sized so as to minimize a dimension of the housing within the range of motion and correspondingly increase, with the side chamfer, freedom of movement of the robotic multi-link arm in the range of motion and maximize the range of motion.

6. The labware transport apparatus of claim 4, wherein the housing is a column rising through the range of motion.

7. The labware transport apparatus of claim 4, wherein the robotic multi-link arm has a shoulder axis that is fixed and offset from the housing, and the offset is sized to provide maximum range of motion effecting end effector access to labware space throughout about 360° around the shoulder axis.

8. The labware transport apparatus of claim 7, wherein the substantially vertical axis of motion is fixed in a predetermined orientation and 360° access is effected singularly via link articulation of the robotic multi-link arm in the range of motion.

9. The labware transport apparatus of claim 1, further comprising at least one sensor disposed on at least one arm link of the multi-link arm so that the sensor senses one or more of a labware pose, labware holding location pose, and obstructions located underneath or above the multi-link arm.

10. The labware transport apparatus of claim 9, wherein the at least one sensor is a ranging sensor.

11. A labware transport apparatus comprising:
a frame defining a labware space; and
a robotic multi-link arm, articulated so that the robotic multi-link arm is selectably compliant, the robotic multi-link arm is operably connected to the frame, via a drive section, disposed to extend and retract the robotic multi-link arm so as to extend and retract an end effector of the robotic multi-link arm in the labware space along an extension axis, and displace the end effector side to side along a transverse axis angled relative to the extension axis, the extension axis and transverse axis angled thereto define a level range of motion of the end effector of the robotic multi-link arm;
wherein the robotic multi-link arm has a predetermined link configuration determining a minimum footprint of the robotic multi-link arm and a corresponding maximum reach of the end effector within the level range of motion; and
wherein the level range of motion, at least in part of the labware space, of the end effector is determined by extension of a shape formed by a substantially upright axis of motion of the drive section, through the level range of motion, and the shape has a configuration based on and disposed so as to maximize the level range of motion of the end effector of the robotic multi-link arm having the predetermined link configuration that is common determining the minimum foot print and the corresponding maximum reach.

12. The labware transport apparatus of claim 11, wherein the substantially upright axis of motion delimits arm motion traversing the end effector on the transverse axis, or on the extension axis of the range of motion.

13. The labware transport apparatus of claim 11, wherein the substantially upright axis of motion interferes with at least one of extension and transverse motion of at least one link of the multi-link arm.

14. The labware transport apparatus of claim 11, wherein the substantially upright axis of motion comprises a housing, and the housing forms an interference to arm motion within the level range of motion.

15. The labware transport apparatus of claim 14, wherein the housing has as a side chamfer sized so as to minimize a dimension of the housing within the level range of motion and correspondingly increase, with the side chamfer, freedom of movement of the robotic multi-link arm in the level range of motion and maximize the level range of motion.

16. The labware transport apparatus of claim 14, wherein the housing is a column rising through the level range of motion.

17. The labware transport apparatus of claim 14, wherein the robotic multi-link arm has a shoulder axis that is fixed and offset from the housing, and the offset is sized to provide maximum range of motion effecting end effector access to labware space throughout about 360° around the shoulder axis.

18. The labware transport apparatus of claim 17, wherein the substantially upright axis of motion is fixed in a predetermined orientation and 360° access is effected singularly via link articulation of the robotic multi-link arm in the level range of motion.

19. The labware transport apparatus of claim 11, further comprising at least one sensor disposed on at least one arm link of the multi-link arm so that the sensor senses one or more of a labware pose, labware holding location pose, and obstructions located underneath or above the multi-link arm.

20. The labware transport apparatus of claim 19, wherein the at least one sensor is a ranging sensor.

21. A labware transport apparatus comprising:
a frame defining a labware space;
a drive section coupled to the frame and having a substantially vertical axis of motion;
a robotic multi-link arm coupled to the substantially vertical axis of motion for substantially vertical movement of the robotic multi-link arm within the labware space, where the drive section is disposed to extend and retract the robotic multi-link arm so as to extend and retract an end effector of the robotic multi-link arm in the labware space along an extension axis, and displace the end effector side to side along a transverse axis angled relative to the extension axis, the extension axis and transverse axis angled thereto define a range of motion of the end effector of the robotic multi-link arm; and
at least one sensor disposed on the robotic multi-link arm, each of the at least one sensor having a field of view extending along the substantially vertical axis of motion and being configured to sense one or more of a labware pose, labware holding location pose, and obstructions located one or more of underneath and above the multi-link arm along the substantially vertical axis of motion.

22. The labware transport apparatus of claim 21, further comprising a controller coupled to the at least one sensor, the controller being configured to, based on input from the at least one sensor, offset a position of the robotic multi-link arm within the range of motion to effect one or more of picking and placing of labware within the range of motion.

23. The labware transport apparatus of claim 21, further comprising a controller coupled to the at least one sensor, the controller being configured to, based on input from the at least one sensor, slow or stop motion of the robotic multi-link arm along the substantially vertical axis of motion with an obstruction within a substantially vertical movement path of the robotic multi-link arm.

24. The labware transport apparatus of claim 21, wherein the at least one sensor comprises one or more of a ranging sensor, an optical sensor, an inductance sensor, and a sonic sensor.

25. The labware transport apparatus of claim 21, wherein:
the robotic multi-link arm has a predetermined link configuration determining a minimum footprint of the robotic multi-link arm and a corresponding maximum reach of the end effector within the range of motion; and
the range of motion, at least in part of the labware space, of the end effector is delimited by a blockage of the substantially vertical axis of motion, of the drive section, extending through the range of motion, wherein the blockage is sized and shaped based on and so as to maximize the range of motion of the end effector of the robotic multi-link arm having the predetermined link configuration that is common determining the minimum foot print and the corresponding maximum reach.

26. The labware transport apparatus of claim 25, wherein the blockage is formed by a housing of the substantially vertical axis of motion, and the housing forms an interference to arm motion within the range of motion.

27. The labware transport apparatus of claim 26, wherein the robotic multi-link arm has a shoulder axis that is fixed and offset from the housing, and the offset is sized to provide maximum range of motion effecting end effector access to labware space throughout about 360° around the shoulder axis.

28. The labware transport apparatus of claim 27, wherein the substantially vertical axis of motion is fixed in a predetermined orientation and 360° access is effected singularly via link articulation of the robotic multi-link arm in the range of motion.
